(19) United States
(12) Patent Application Publication
(10) Pub. No.: US 2013/0065634 A1
(43) Pub. Date: Mar. 14, 2013

(54) METHOD FOR COMMUNICATION OF TERMINAL AND METHOD FOR COMMUNICATION OF BASE STATION

(71) Applicants: Anseok LEE, Daejeon (KR); Eunkyung KIM, Daejeon (KR); Sung Cheol CHANG, Daejeon (KR); Sung Kyung KIM, Daejeon (KR); Won-Ik KIM, Daejeon (KR); Mi Young YUN, Daejeon (KR); Hyun LEE, Daejeon (KR); Kwang Jae LIM, Daejeon (KR); DongSeung KWON, Daejeon (KR)

(72) Inventors: Anseok LEE, Daejeon (KR); Eunkyung KIM, Daejeon (KR); Sung Cheol CHANG, Daejeon (KR); Sung Kyung KIM, Daejeon (KR); Won-Ik KIM, Daejeon (KR); Mi Young YUN, Daejeon (KR); Hyun LEE, Daejeon (KR); Kwang Jae LIM, Daejeon (KR); DongSeung KWON, Daejeon (KR)

(73) Assignee: Electronics and Telecommunications Research Institute, Daejeon (KR)

(21) Appl. No.: 13/608,368

(22) Filed: Sep. 10, 2012

(30) Foreign Application Priority Data
Sep. 9, 2011 (KR) 10-2011-0092197
Nov. 1, 2011 (KR) 10-2011-0112607
May 4, 2012 (KR) 10-2012-0047416
Aug. 16, 2012 (KR) 10-2012-0089728

(51) Int. Cl. H04W 36/08

(52) U.S. Cl. 455/525

(57) ABSTRACT

A method for communication of a terminal and a method for communication of a base station are disclosed. Communication between a first base station with a problem in a backbone and a second base station located beyond the coverage of the degraded base station and neighboring the first base station is relayed by a terminal. Accordingly, the first base station is able to continuously provide service to subordinate stations.

### CROSS-REFERENCE TO RELATED APPLICATION

This application claims priority to and the benefit of Korean Patent Application No. 10-2011-0092197, 10-2011-0112607, 10-2012-0047416, and 10-2012-0089728 filed in the Korean Intellectual Property Office on Sep. 9, 2011, Nov. 1, 2011, May, 4 2012, and Aug. 16, 2012, the entire contents of which are incorporated herein by reference.

### BACKGROUND OF THE INVENTION

(a) Field of the Invention

The present invention relates to a method of communication of a terminal and a method for communication of a base station.

(b) Description of the Related Art

In a mobile communication system, a base station has a structure such that it connects to a router using a wired interface, such as ATM (asynchronous transfer mode) and Ethernet, which is referred to as a wired backbone link of the base station.

When the wired backbone link of the base station in such a mobile communication system is damaged due to a disaster or other event, subordinate stations within a cell fail to receive services from the base station. A failed mobile communication service caused by the damage to the wired backbone link may bring about significant problems in rescue and disaster recovery.

There is a need for high-reliability support, i.e., a technique for improving the reliability of a mobile communication network, which makes a mobile communication service available even in case of such problems.

A conventional method that makes mobile communication service available even when the wired backbone link is damaged includes a method for gaining backbone connectivity of the damaged base station through a wireless link to a neighboring base station. That is, by the use of a neighboring base station, a wireless backbone link is provided to the base station with a damaged wired backbone link.

However, if no neighboring base stations that are capable of providing a direct link to the base station of which the backbone link is damaged exist, no method for recovering a backbone connection of the damaged base station exists. As a result, the subordinate stations within the cell serviced by the base station of which the backbone link is damaged loose service.

### SUMMARY OF THE INVENTION

The present invention has been made in an effort to continuously provide a mobile communication service to subordinate stations even when some problem occurs with a wired backbone link of a base station.

An exemplary embodiment of the present invention provides a method for communication of a terminal. The method for communication of a terminal includes: being selected a terminal establishing a first connection between a first base station with a problem in backbone connection and a second base station located beyond a coverage of the first base station and neighboring the first base station; performing handover to create the first connection; and creating the first connection between the first base station and the second base station.

The being selected of as the terminal may include receiving a first message requesting to search for the second base station from the first base station, and sending a second message containing a searching information about the second base station to the first base station. The first message may be a scanning response message (SCN-RSP or AAI-SCN-RSP), and the second message may be a scanning response message (SCN-REP or AAI-SCN-REP).

The performing of handover may include receiving a handover command message from the first base station, and performing handover to the second base station. The performing of handover to the second base station may include sending a ranging request (RNG-REQ or AAI-RNG-REQ) message to the second base station.

The handover command message and the ranging request message may include an indication of handover for the first connection.

The ranging request message may include a primary serving base station flag of the terminal.

After the performing of handover, the terminal may maintain information of the first base station.

The method for communication of a terminal may further include accessing the first base station during a first time period, and accessing the second base station during a second time period different from the first time period.

The accessing of the first base station or the second base station may include sending an access request to each of the base stations, receiving an access response from each of the base stations, and exchanging data with each of the base stations.

The first time period and the second time period may be fixed or variable.

The creating of the first connection may include performing a dynamic service addition (DSA) procedure with the first base station, and performing a dynamic service addition (DSA) procedure with the second base station.

A downlink (DL) connection of the first base station may be coupled with an uplink (UL) connection of the second base station, and a downlink (DL) connection of the second base station may be coupled with an uplink (UL) connection of the first base station.

The method for communication of a terminal may further include terminating the first connection when the backbone is recovered or there is no connection to be serviced by the first connection.

The terminating of the first connection may include: sending a handover request for connection termination to a secondary serving base station, which is either the first base station or the second base station; receiving a handover command from the secondary serving base station; and sending a switched access termination request to a primary serving base station, which is either the first base station or the second base station.

The method for communication of a terminal may further include terminating the first connection if it is difficult for the terminal to maintain a wireless link shared with the first base station or the second base station.

The method for communication of a terminal may further include terminating the first connection if the terminal satisfies the condition for handover to the first base station or the second base station.

The terminating of the first connection may include sending a handover request for connection termination to the base station for which it is difficult to maintain the wireless link, receiving a handover command from the base station for which it is difficult to maintain the wireless link, and sending a switched access termination request to the base station for which it is difficult to maintain the wireless link.

Another exemplary embodiment of the present invention provides a method for communication of a base station. The method for communication of a base station includes: selecting a base station located beyond coverage and neighboring if a problem occurs in a backbone connection; selecting a terminal to establish a first connection with the base station; sending a command to perform handover to the base station to the terminal; and creating the first connection with the terminal.

Yet another exemplary embodiment of the present invention provides a method for communication of a base station. The method for communication of a base station includes being selected a base station which provides a core network to a base station with a problem in a backbone by a first connection using a terminal, performing reentry of the terminal, and creating the first connection with the terminal.

According to an exemplary embodiment of the present invention, a base station is able to continuously provide a mobile communication service to subordinate stations by relaying backbone data through a forwarding terminal even when a problem occurs in the wired backbone link of the base station.

### BRIEF DESCRIPTION OF THE DRAWINGS

FIG. 1 is a view showing the occurrence of a failure in a wired backbone link of a base station in a mobile communication system according to an exemplary embodiment of the present invention.

FIG. 2 is a view showing a method for forwarding between base stations using a designated HR-MS in a mobile communication system according to an exemplary embodiment of the present invention.

FIG. 3 is a flowchart schematically showing a method for forwarding between base stations using a terminal in a mobile communication system according to an exemplary embodiment of the present invention.

FIG. 4 is a view showing the searching of a designated HR-MS and a target HR-BS in a mobile communication system according to an exemplary embodiment of the present invention.

FIG. 5 is a view showing a handover for FBIS connection creation in a mobile communication system according to an exemplary embodiment of the present invention.

FIG. 6 is a view showing a method in which a designated HR-MS accesses a degraded HR-BS and a target HR-BS through a variable switched access window in a mobile communication system according to an exemplary embodiment of the present invention.

FIG. 7 is a view showing a method in which a designated HR-MS accesses a degraded HR-BS and a target HR-BS through a fixed switched access window in a mobile communication system according to an exemplary embodiment of the present invention.

FIG. 8 is a view showing a procedure for creating an FBIS connection in a mobile communication system according to an exemplary embodiment of the present invention.

FIG. 9 is a view showing that an FBIS connection is terminated upon backbone recovery in a mobile communication system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In this specification, a mobile station (MS) may designate a terminal, a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the terminal, the MT, the MS, the AMS, the HR-MS, the SS, the PSS, the AT, the UE, etc.

In this specification, a base station (BS) may designate an advanced base station (ABS), a high reliability base station (HR-BS), a nodeB, an evolved nodeB (eNodeB), an access point (AP), a radio access station (RAS), a base transceiver station (BTS), a mobile multihop relay (MMR-BS), a relay station (RS) serving as a base station, a high reliability relay station (HR-RS) serving as a base station, etc., and may include the entire or partial functions of the ABS, the nodeB, the eNodeB, the AP, the RAS, the BTS, the MMR-BS, the RS, the HR-RS, etc.

Now, a method for communication of a terminal and a method for communication of a base station will be described in detail with reference to the drawings.

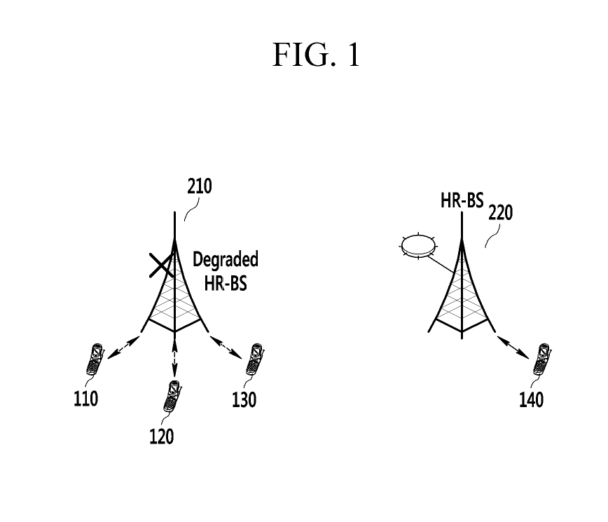

FIG. 1 is a view showing the occurrence of a failure in a wired backbone link of a base station in a mobile communication system according to an exemplary embodiment of the present invention.

As shown in FIG. 1, the mobile communication system according to the exemplary embodiment of the present invention includes base stations 210 and 220 and subordinate stations 110, 120, 130, and 140 within cells serviced by the base stations 210 and 220. The base station 210 is a base station that has lost the functionality of a wired backbone link, and is referred to as a degraded HR-BS (high reliability base station).

The subordinate stations 110, 120, and 130 within the serving cell have a problem in mobile communication service due to the degradation in the functionality of the wired backbone link of the degraded HR-BS 210; however, in the exemplary embodiment of the present invention, data and a control message are relayed using a forwarding terminal capable of relaying a backbone connection to a neighboring base station. The forwarding terminal relaying a backbone connection to a neighboring base station is referred to as a designated HR-MS.

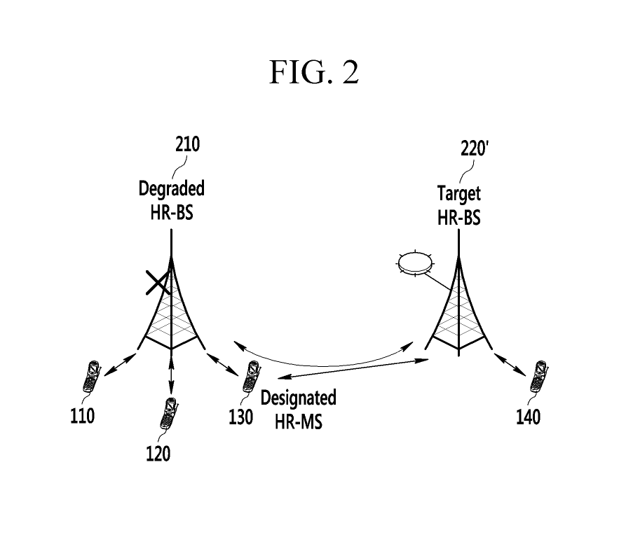

FIG. 2 is a view showing a method for forwarding between base stations using the designated HR-MS 130 in a mobile communication system according to an exemplary embodiment of the present invention.

As shown in FIG. 2, the degraded HR-BS 210 performs forwarding to a base station 220′ through the designated HR-MS 130, thereby recovering the backbone. The base station 220′ which ultimately deliverying the data of the degraded HR-BS 210 to the core network through the designated HR-MS 130 is referred to as a target HR-BS.

Such a function of forwarding between base stations using a terminal is referred to as “FBIS” (forwarding between infrastructure stations). That is, in the method for forwarding between base stations using a terminal according to the exemplary embodiment of the present invention, an FBIS connection to a neighboring base station can be created using at least one designated HR-MS 130, thereby recovering the wired backbone of a base station.

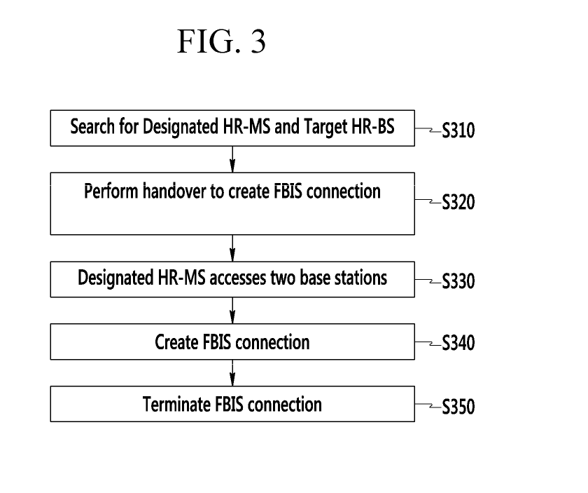

Hereinafter, a method for forwarding between base stations using a terminal in a mobile communication system according to an exemplary embodiment of the present invention will be described in detail with reference to FIGS. 3 to 9.

FIG. 3 is a flowchart schematically showing a method for forwarding between base stations using a terminal in a mobile communication system according to an exemplary embodiment of the present invention.

First, a degraded HR-BS searches for at least one designated HR-MS among one or more terminals belonging to a cell of the degraded HR-BS (S310). Herein, a terminal capable of connecting to a target HR-BS beyond the coverage of the degraded HR-BS is selected as a designated HR-MS.

To create an FBIS connection, the designated HR-MS that has received a handover command from the degraded HR-BS performs handover to the target HR-BS (S320).

Next, the designated HR-MS accesses the degraded HR-BS and the target HR-BS (S330), and then creates an FBIS connection by a DSA (dynamic service addition) procedure (S340). Once the FBIS connection is created, data transmission through the designated HR-MS to the core network is possible.

When the degraded HR-BS finally recovers the wired backbone connection, there is no longer a need to maintain the FBIS connection using the designated HR-MS, so the FBIS connection is terminated (S350).

The steps shown in FIG. 3 will be described in more detail with reference to FIGS. 3 to 9.

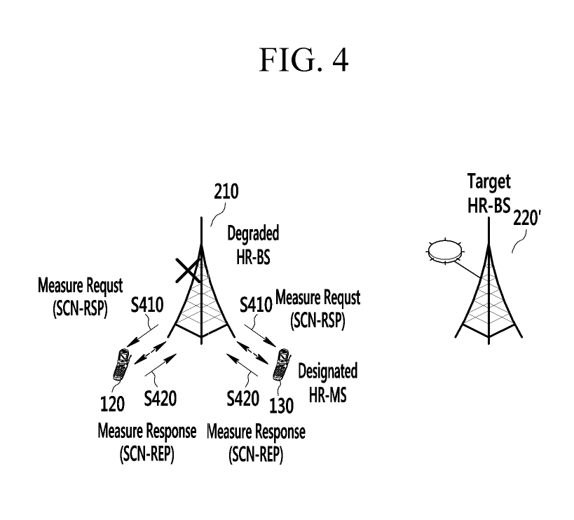

First, the step S310 of FIG. 3 will be described in detail with reference to FIG. 4.

FIG. 4 is a view showing the searching of a designated HR-MS and a target HR-BS in a mobile communication system according to an exemplary embodiment of the present invention.

The degraded HR-BS 210, which has lost the wired backbone link, reports a backbone connection failure to the subordinate stations 120 and 130, and at the same time requests the subordinate stations 120 and 130 to measure a channel in order to search for a neighboring base station (S410). A terminal requested to measure a channel is limited to a node capable of forwarding between base stations. The backbone connection failure report or the channel measurement request is delivered through a measure request message. The measure request message may further include BSIDs, preambles, etc. of neighboring base stations. Meanwhile, the measure request message may be transmitted using a scanning response (SCN-RSP) message or an advanced air interface scanning response (AAI-SCN-RSP) message.

Upon receiving the backbone connection failure report or the channel measurement request through the measure request message, the subordinate stations 120 and 130 report channel search information (including information of neighboring base stations) to the degraded HR-BS 210 through a measure response message (S420). If the subordinate stations 120 and 130 periodically search neighboring base stations, they can transmit a measurement result without a scanning procedure, or if the subordinate stations 120 and 130 have no neighboring base station search information, they can perform a scanning procedure and transmit the result through the measure response message. The measure response message may include identifier BSIDs, preamble information, etc. of neighboring base stations. Meanwhile, the measure response message may be transmitted using a scanning reply (SCN-REP) message or advanced air interface scanning reply (AAI-SCN-REP) message.

The degraded HR-BS 210 selects at least one terminal as the designated HR-MS based on information of the measure response message received from the subordinate stations 120 and 130. As shown in FIG. 4, the terminal 130 among the subordinate stations is selected as the designated HR-MS, and a neighboring base station to which data of the degraded HR-BS 210 is forwarded through the designated HR-MS is selected as the target HR-BS 220′. As for a method for selecting the designated HR-MS 130, a terminal having the best channel environment can be selected as the designated HR-MS by taking into account the quality of two wireless links, i.e., between the degraded HR-BS and the designated HR-MS and between the designated HR-MS and the target HR-BS.

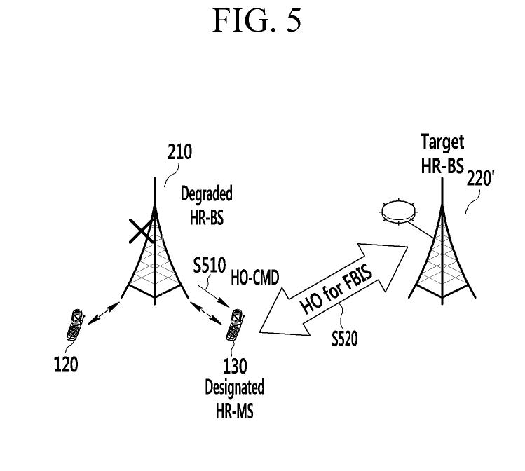

Next, the step S320 of FIG. 3 will be described in detail with reference to FIG. 5.

FIG. 5 is a view showing a handover for FBIS connection creation in a mobile communication system according to an exemplary embodiment of the present invention.

First, the degraded HR-BS 210 sends a handover command for FBIS to the designated HR-MS 130 (S510). This handover command is sent through an advanced air interface handover command (AAI-HO-CMD) message, and upon receiving this handover command AAI-HO-CMD message, the designated HR-MS 130 performs handover to the target HR-BS 220′ (S520).

The handover command (AAI-HO-CMD) message indicates that the type of handover is a handover for FBIS. The handover command (AAI-HO-CMD) message further includes a primary serving base station flag. After performing the handover for FBIS using the primary serving base station flag, the designated HR-MS 130 can establish a primary connection to the degraded HR-BS 210 or the target HR-BS 220′. If the primary serving base station flag is 0, the primary serving HR-BS of the designated HR-MS 130 can be selected as the degraded HR-BS 210 after handover is performed. If the primary serving base station flag is 1, the primary serving HR-BS of the designated HR-MS 130 can be selected as the target HR-BS 220′ after handover is performed.

Meanwhile, the designated HR-MS 130 may establish a primary connection to the target HR-BS 220′ in order to receive its service from the target HR-BS 220′ after handover is performed. If the designated HR-MS 130 is required to maintain service to other terminals under the degraded HR-BS 210 which has lost the backbone, the primary connection to the degraded HR-BS 210 may be maintained even after handover is performed. For convenience of explanation, the following description will be made on the assumption that the designated HR-MS 130 establishes a primary connection to the target HR-BS 220′.

In general, in a handover (HO) of the designated HR-MS 130, information exchange cannot be performed through the wired backbone link between the degraded HR-BS 210 and the target HR-BS 220′, whereby optimized handover cannot be performed and instead uncoordinated handover is performed.

If the primary serving HR-BS of the designated HR-MS 130 is the target HR-BS 220′, forwarding is performed from the degraded HR-BS 210 to the target HR-BS 220′ after handover and FBIS connection are performed, and therefore service can be received from the target HR-BS 220′.

To perform handover, the designated HR-MS 130 transmits a ranging request (RNG-REQ) message or advanced air interface ranging request (AAI-RNG-REQ) message to the target HR-BS 220′. The ranging request (RNG-REQ) message indicates that the handover is a handover for FBIS. From this information, the target HR-BS 220′ is aware that uncoordinated handover is required.

After performing the handover procedure, the designated HR-MS 130 does not discard but instead maintains information of the degraded HR-BS 210, which is the existing base station, and the degraded HR-BS 210 also maintains information of the designated HR-MS 130. This enables the creation of an FBIS connection and the data transmission for FBIS connection between the degraded HR-BS and the designated HR-MS after the handover procedure is performed.

If the network supports multi-carriers and the degraded HR-BS 210 and the target HR-BS 220′ use different carriers, this enables multi-carrier handover (MCHO) of the designated HR-MS 130. In this case, the designated HR-MS 130 is able to perform a handover procedure to the target HR-BS 220′ by using a different carrier from a carrier communicating with the degraded HR-BS 210, and maintains the connection to the degraded HR-BS 210.

After the designated HR-MS 130 completes the handover procedure, it operates while maintaining the connection to the two base stations, i.e., the degraded HR-BS 210 and the target HR-BS 220′, and accordingly the designated HR-MS 130 is capable of data exchange with the degraded HR-BS 210 and the target HR-BS 220′. However, in case of a network that does not support multi-carriers, or in the case that the degraded HR-BS 210 and the target HR-BS 220′ use the same carrier even if multi-carriers are supported, the designated HR-MS 130 cannot simultaneously access the two base stations i.e., the degraded HR-BS 210 and the target HR-BS 220′. Accordingly, according to an exemplary embodiment of the present invention, the designated HR-MS 130 can access the degraded HR-BS 210 and the target HR-BS 220′ at separate times.

Such an access method is called a switched access method, and the switched access enables data exchange with two base stations of which the designated HR-MS has completed association with and entry into. A window during which the designated HR-MS performs communication with each base station is referred to as a switched access window.

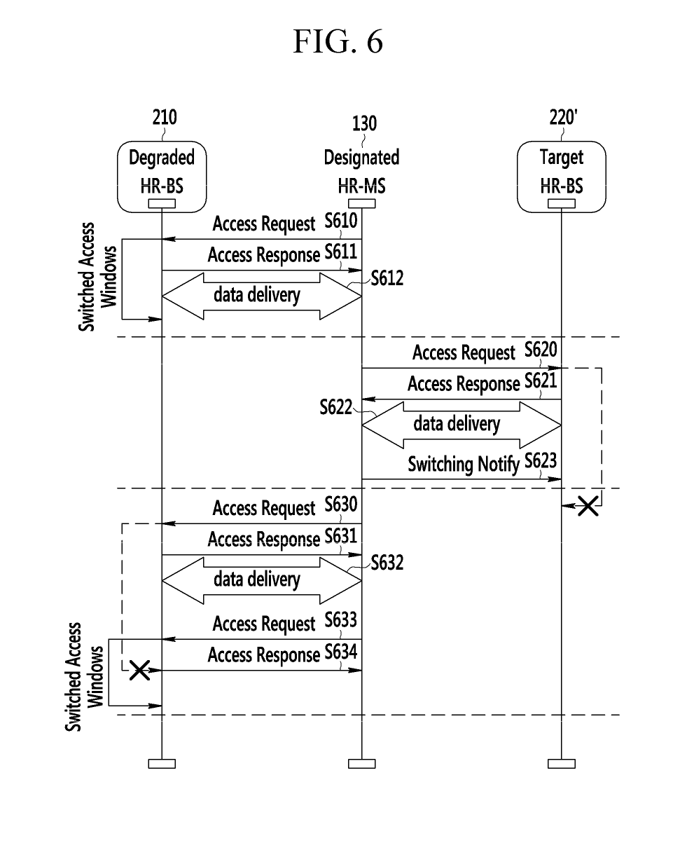

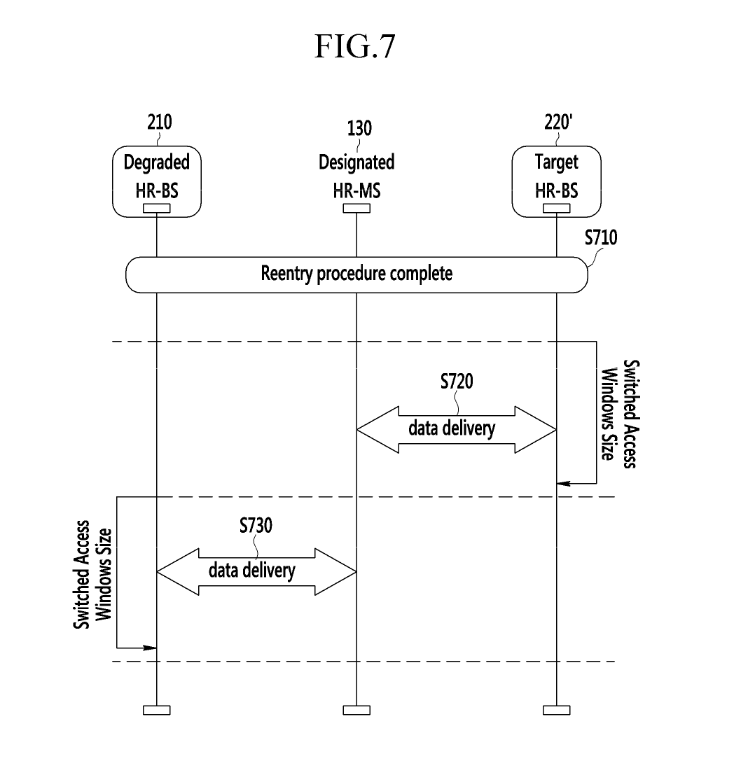

The length of the switched access window is variable or fixed. Switched access methods for both will be described with reference to FIGS. 6 and 7.

FIG. 6 is a view showing a method in which a designated HR-MS accesses a degraded HR-BS and a target HR-BS through a variable switched access window in a mobile communication system according to an exemplary embodiment of the present invention.

As shown in FIG. 6, to start switched access, the designated HR-MS 130 transmits an access request to the degraded HR-BS 210 or target HR-BS 220′ desired to be accessed (S610, S620, and S630). The access request is transmitted through a switched access control signaling header, which is a signaling header for switched access control. The access request includes an access request indication and a requested switched access window size.

Upon receipt of the access request, the degraded HR-BS 210 or target HR-BS 220′ transmits a response to the access request to the designated HR-MS 130 through an access response, and the access response is also transmitted through the switched access control signaling header. The access response includes status indicative of the permission of requested access and a permitted switched access window.

The designated HR-MS 130 performs data exchange with the degraded HR-BS 210 or target HR-BS 220′ during the permitted switched access window (S612, S622, and S632), and then switches to another base station. The designated HR-MS 130 performs a requesting procedure through an access request in the same manner in order to start a switched access window for another base station.

When it is desired to extend the permitted switched access window before expiration of the designated HR-MS 130, the designated HR-MS 130 transmits an access request so that it is allocated a new switched access window (S633 and S634). Although FIG. 6 illustrates that the designated HR-MS 130 transmits the access request, the degraded HR-BS 210 or target HR-BS 220′ may also transmit the access request.

Meanwhile, when the designated HR-MS 130 needs to communicate with another base station before the permitted switched access window has elapsed, the designated HR-MS may transmit a switching notification (S623). The switching notification is also transmitted through the switched access control signaling header.

FIG. 7 is a view showing a method in which a designated HR-MS accesses a degraded HR-BS and a target HR-BS through a fixed switched access window in a mobile communication system according to an exemplary embodiment of the present invention.

In order for the designated HR-MS to perform switched access to the degraded HR-BS and the target HR-BS, it is required to determine the length of a fixed switched access window in the above-described handover procedure.

When a handover command (HO-CMD) message transmitted by the degraded HR-BS is used to issue a handover command for FBIS connection, the handover command (HO-CMD) message may include switched access mode, which is a parameter for indicating whether fixed switched access is performed or not. If the switched access mode is set to “0”, this indicates fixed switched access.

When performing a reentry procedure to the target HR-BS (see S520 of FIG. 5), the designated HR-MS reports the switched access mode and the length of the switched access window through a ranging request (RNG-REQ) message. By this, the designated HR-MS is able to perform switched access between two base stations without the procedure of requesting and allocating the length of the switched access window.

As shown in FIG. 7, after completion of the reentry procedure (S710), the designated HR-MS 130 exchanges data with the target HR-BS 220′ during the fixed switched access window (S720), and then exchanges data with the degraded HR-BS 210.

Meanwhile, an access request and an access response may be transmitted through a control message, rather than through a signaling header.

When performing a handover procedure through the above-explained multi-carrier controlled handover (MCHO), the designated HR-MS can simultaneously access two base stations without the use of a switched access method. Meanwhile, the designated HR-MS that performs simultaneous access continuously receives service for its connection, rather than the FBIS connection, through the target HR-BS.

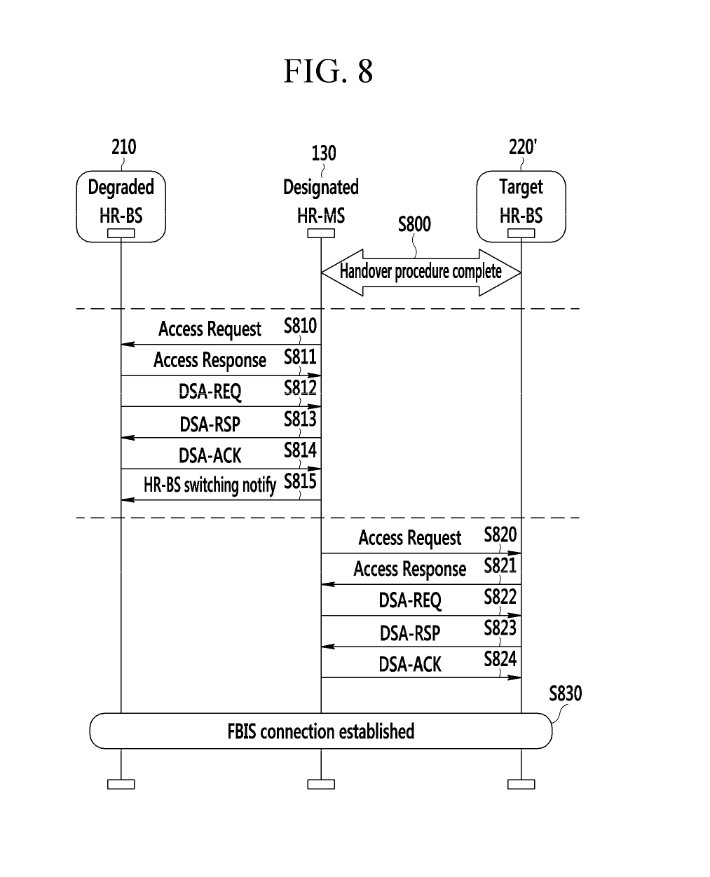

Referring to FIG. 8, a method for creating an FBIS connection will be described in detail.

After completion of the handover procedure (S800), the degraded HR-BS 210 starts the procedure of creating an FBIS connection using the designated HR-MS 130. This procedure is performed through DSA (dynamic service addition). This procedure can be omitted if the fixed access window explained in FIG. 7 is used.

FIG. 8 is a view showing a procedure for creating an FBIS connection in a mobile communication system according to an exemplary embodiment of the present invention.

First, the designated HR-MS 130 sends an access request and receives an access response to and from the degraded HR-BS 210 in order to access the degraded HR-BS 210 (S810 and S811).

Next, the degraded HR-BS 210 transmits a dynamic service addition request (DSA-REQ) message to the designated HR-MS 130, and the designated HR-MS 130 transmits a dynamic service addition response (DSA-RSP) message to the degraded HR-BS 210 (S813). Meanwhile, the degraded HR-BS 210 transmits a dynamic service addition acknowledgment (DSA-ACK) message to the designated HR-MS 130 (S814).

The dynamic service addition request (DSA-REQ) message transmitted by the degraded HR-BS 210 indicates that a currently created service flow is for an FBIS connection. To this end, the dynamic service addition request (DSA-REQ) message includes an FBIS connection Indication field.

The dynamic service addition request (DSA-REQ) message transmitted by the degraded HR-BS 210 may include a service parameter, and the service parameter may include a QoS (quality of service)-related parameter of the FBIS connection.

An FBIS connection may be created in different directions for the incoming traffic and outgoing traffic of the backbone link of the degraded HR-BS 210. The incoming traffic is in an uplink (UL) for the degraded HR-BS 210 and the designated HR-MS 130, and the outgoing traffic is in a downlink (DL) for the degraded HR-BS 210 and the designated HR-MS 130.

After FBIS connections are created for the uplink (UL) and downlink (DL) between the degraded HR-BS 210 and the designated HR-MS 130, the designated HR-MS 130 sets up an FBIS connection to the target HR-BS 220′. The establishment of an FBIS connection between the degraded HR-BS 210 and the designated HR-MS 130 is performed by dynamic service addition (DSA), and is initiated by the designated HR-MS 130 (S820, S821, S823, and S824). The uplink (UL) connection between the degraded HR-BS 210 and the designated HR-MS 130 is coupled with the downlink (DL) connection of the degraded HR-BS 210, and the downlink (DL) connection between the designated HR-MS 130 and the target HR-BS 220′ is coupled with the uplink (UL) connection of the degraded HR-BS 210.

Meanwhile, the dynamic service addition request (DSA-REQ) message transmitted from the designated HR-MS 130 to the target HR-BS 220′ may include the service parameter of the dynamic service addition request (DSA-REQ) message received from the degraded HR-BS 210.

Once an FBIS connection is established through the designated HR-MS 130 (S830), the degraded HR-BS 210 may replace the wired backbone connection with the FBIS connection using a terminal.

An upper layer of the degraded HR-BS 210 performs the transmission of a service data unit (SDU) over a mobile communication network to forward uplink (UL) data that needs to be forwarded to the core network. To this end, the service data unit (SDU) is forwarded to a MAC (medium access control) layer. Upon receipt of the Service Data Unit (SDU) to be forwarded, the MAC layer maps it to the FBIS connection using the designated HR-MS 130 based on the classification rule of a convergence sublayer. The classification rule of the convergence sublayer may be created in the dynamic service addition (DSA) procedure between the degraded HR-BS 210 and the designated HR-MS130.

The target HR-BS 220′ receives downlink (DL) of the degraded HR-BS 210 from the core network of the target HR-BS 220′, and an upper layer of the target HR-BS forwards the data received from the core network to a MAC layer so as to forward it over a mobile communication network. The MAC layer maps the data to the FBIS connection using the designated HR-MS 130 based on the classification rule of a convergence sublayer. The classification rule of the convergence sublayer may be created in the dynamic service addition (DSA) procedure between the target HR-BS 220′ and the designated HR-MS130.

Meanwhile, when transmitting data of an upper layer through an FBIS connection, the flow ID (FID) of a MAC header is selected as the flow ID (FID) of the FBIS connection. Thus, upon receipt thereof, the designated HR-MS 130 determines whether the data is for FBIS connection or not. Here, an upper layer of the designated HR-MS 130 is not involved in relaying an FBIS connection.

Having completed the creation of an FBIS connection, the degraded HR-BS 210 is able to exchange an upper layer control message with a neighboring base station or control station, as well as provide service to its subordinate stations, by means of the FBIS connection.

Having created the FBIS connection, the degraded HR-BS may notify the subordinate stations of backbone connection recovery, and permit the entry of a new node or the entry of a node that sends a request for handover from a neighboring cell.

In addition to the above-described method of forwarding upper layer data through an established FBIS connection, a method of transmitting a service data unit (SDU) of an upper layer through a control message may be applied. To this end, an L2-XFER (L2-transfer) message, which is a control message that may include the service data unit (SDU) of the upper layer, may be used.

An attribute change, addition, or deletion of the service being relayed through an FBIS connection can be made by a service parameter modification procedure. The service parameter of the FIBIS connection can be modified by a dynamic service change (DSC) between the degraded HR-BS 210 and the designated HR-MS 130. Having completed the DSC procedure with the degraded HR-BS 210, the designated HR-MS 130 performs the DSC procedure with the target HR-BS 220′ so that the target HR-BS 220′ is informed of a changed service parameter.

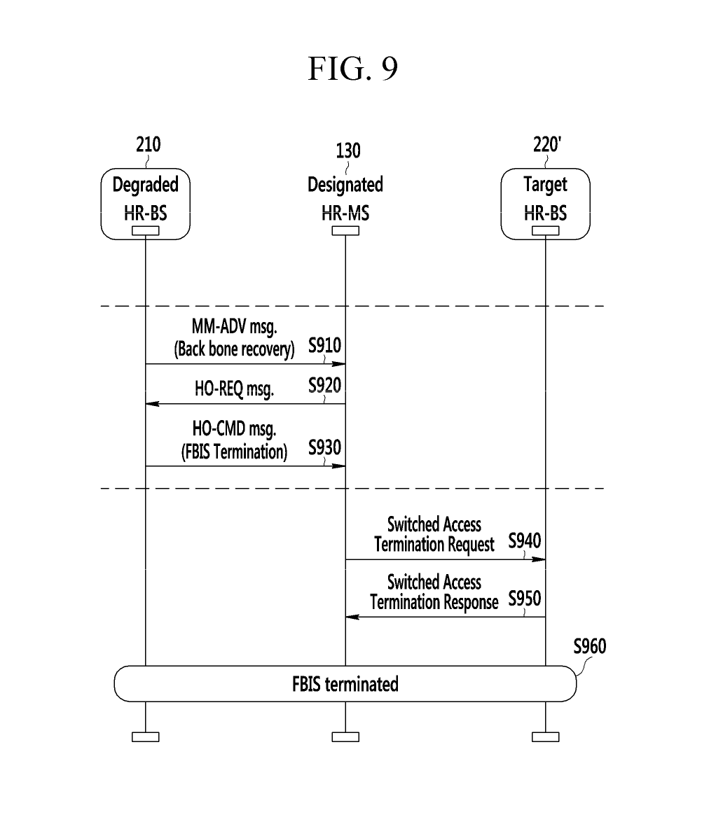

Next, a method of terminating an FBIS connection will be described in detail with reference to FIG. 9.

FIG. 9 is a view showing that an FBIS connection is terminated upon backbone recovery in a mobile communication system according to an exemplary embodiment of the present invention.

Since the degraded HR-BS 210 recovers the backbone, it does not need to maintain the FBIS connection using the designated HR-MS 130. The degraded HR-BS 210 transmits an MM-ADV (multimode advertisement) message to the designated HR-MS 130 to report backbone recovery (S910). Upon receipt of this message, the designated HR-MS 130 terminates the connection with the degraded HR-BS 210 or the target HR-BS 220′.

Once the backbone connection is recovered, the designated HR-MS 130 terminates the connection with the secondary serving base station while maintaining the connection with the primary serving base station. That is, when the primary serving base station is the target HR-BS 220′, the designated HR-MS 130 terminates the connection with the degraded HR-BS 210, and when the primary serving base station is the degraded HR-BS 210, the designated HR-MS 130 terminates the connection with the target HR-BS 220′. The following procedure will be explained with respect to an example where the primaryt serving base station is the target HR-BS 220′.

The designated HR-MS 130 performs the termination of the connection with the degraded HR-BS 210 by a handover (HO) procedure. That is, the designated HR-MS 130 transmits a handover request (HO-REQ) message to the degraded HR-BS 210 (S920), and the handover request (HO-REQ) message indicates FBIS connection termination. Upon receipt of the handover request (HO-REQ) message, the degraded HR-BS 210 transmits a handover command (HO-CMD) message to the designated HR-MS 130 (S930), and the handover command (HO-CMD) message also indicates FBIS connection termination. The degraded HR-BS 210 that has transmitted the handover command (HO-CMD) message for FBIS connection termination and the designated HR-MS 130 that has received the same start a resource retain timer at a given time, and release station information of the opposite party when the set timer has expired.

Having completed the termination of the connection with the degraded HR-BS 210, the designated HR-MS 130 terminates the switched access operation in order to only communicate with the target HR-BS 220′. To terminate the switched access operation, the designated HR-MS 130 transmits a switched access termination request to the target HR-BS 220′ (S940), and the target HR-BS 220′ transmits a switched access termination response to the designated HR-MS 130 (S950). As a result, the FBIS connection is finally terminated (S960).

Also, when there is no more connection to be serviced by the degraded HR-BS 210, as well as when the backbone of the degraded HR-BS 210 is recovered, the FBIS connection is terminated. When there is no more connection to be serviced by the degraded HR-BS 210, the procedure of deleting the FBIS connection is performed through a DSD (dynamic service deletion) procedure. Once the FBIS connection is deleted, the designated HR-MS 130 terminates the base station other than the primary serving base station among the two base stations (the degraded HR-BS and the target HR-BS) and continues to communicate with the primary serving base station, as is the case with backbone recovery.

Moreover, because of the movement or the like of the designated HR-MS 130, either the designated HR-MS 130 or the base station (degraded HR-BS 210 or target HR-BS 220′) maintaining the connection with the designated HR-MS 130 terminates the connection with a base station which performs handover (HO) and satisfies the condition for handover (HO) from the designated HR-MS 130, and the designated HR-MS terminates the switched access in order to only communicate with another base station (i.e., a base station which does not satisfy the condition for handover).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for communication of a terminal, the method comprising:
being selected as a terminal establishing a first connection between a first base station with a problem in backbone connection and a second base station located beyond a coverage of the first base station and neighboring the first base station;
performing handover to create the first connection; and
creating the first connection between the first base station and the second base station.

2. The method of claim 1, wherein the being selected of as the terminal comprises:
receiving a first message requesting to search for the second base station from the first base station; and
sending a second message containing a searched information about the second base station to the first base station.

3. The method of claim 2, wherein the first message is a scanning response message (SCN-RSP or AAI-SCN-RSP), and the second message is a scanning response message (SCN-REP or AAI-SCN-REP).

4. The method of claim 1, wherein the performing of handover comprises:
receiving a handover command message from the first base station; and
performing handover to the second base station.

5. The method of claim 4, wherein the performing of handover to the second base station comprises sending a ranging request (RNG-REQ or AAI-RNG-REQ) message to the second base station.

6. The method of claim 5, wherein the handover command message and the ranging request message comprise an indication of handover for the first connection.

7. The method of claim 5, wherein the ranging request message comprises a primary serving base station flag of the terminal.

8. The method of claim 1, wherein, after the performing of handover, the terminal maintains information of the first base station.

9. The method of claim 1, further comprising:
accessing the first base station during a first time period; and
accessing the second base station during a second time period different from the first time period.

10. The method of claim 9, wherein the accessing of the first base station or the second base station comprises:
sending an access request to each of the base stations;
receiving an access response from each of the base stations; and
exchanging data with each of the base stations.

11. The method of claim 9, wherein the first time period and the second time period are equal and fixed.

12. The method of claim 1, wherein the creating of the first connection comprises:
performing a dynamic service addition (DSA) procedure with the first base station; and
performing a dynamic service addition (DSA) procedure with the second base station.

13. The method of claim 12, wherein a downlink (DL) connection of the first base station is coupled with an uplink (UL) connection of the second base station, and a downlink (DL) connection of the second base station is coupled with an uplink (UL) connection of the first base station.

14. The method of claim 1, further comprising terminating the first connection when the backbone is recovered or there is no connection to be serviced by the first connection.

15. The method of claim 14, wherein the terminating of the first connection comprises:
sending a handover request for connection termination to a secondary serving base station, which is either the first base station or the second base station;
receiving a handover command from the secondary serving base station; and
sending a switched access termination request to a primary serving base station, which is either the first base station or the second base station.

16. The method of claim 1, further comprising terminating the first connection if it is difficult for the terminal to maintain a wireless link shared with the first base station or the second base station.

17. The method of claim 16, wherein the terminating of the first connection comprises:
sending a handover request for connection termination to the base station for which it is difficult to maintain the wireless link;
receiving a handover command from the base station for which it is difficult to maintain the wireless link; and
sending a switched access termination request to the base station for which it is difficult to maintain the wireless link.

18. A method for communication of a base station, the method comprising:
selecting a base station located beyond coverage and neighboring if a problem occurs in a backbone connection;
selecting a terminal to establish a first connection withthe base station;
sending a command to perform handover to the base station to the terminal; and
creating the first connection with the terminal.

19. A method for communication of a base station, the method comprising:
being selected a base station which provides a core network to a base station with a problem in a backbone by a first connection using a terminal;
performing reentry of the terminal; and
creating the first connection with the terminal.
